(19) United States
(12) Patent Application Publication
(10) Pub. No.: US 2006/0065794 A1
(43) Pub. Date: Mar. 30, 2006

(54) Holding device

(76) Inventors: Helmut Kunkel, Wiesthal (DE); Anton Wirthmann, Gemuenden (DE)

Correspondence Address: STRIKER, STRIKER & STENBY, 103 EAST NECK ROAD, HUNTINGTON, NY, 11743, US

(21) Appl. No.: 11/238,691

(22) Filed: Sep. 29, 2005

(30) Foreign Application Priority Data
Sep. 30, 2004 (DE) 10 2004 047 500.8

(51) Int. Cl. F16L 3/00

(52) U.S. Cl. 248/121

(57) ABSTRACT

A holding device has an electrically controlled holding element, a shaft with a coupling that interacts with the holding element, the holding element being positioned coaxially with the shaft and assuming at least two positions including a first position releasing the shaft and a second position locking the shaft, the holding element and the coupling having a matching surface structure.

### BACKGROUND OF THE INVENTION

The present invention relates to locking of movable axles using a holding device, and a method for carrying out a locking procedure. Devices are also included that aid the holding device according to the present invention.

Movable axles must be lockable, depending on the application. For example, a crane that includes an electric motor and cable winch must block the shaft that drives the cable winch if the motor fails, to prevent the load from crashing to the ground.

Patent document DE 39 42 344 Cl describes a directional rotation lock for a synchronous motor. Teeth are used to prevent the rotor shaft from moving, as necessary.

Unexamined German patent application 26 01 558, which contains all of the features of the definition of the species of the present invention, is the most closely related art. The braking device described is designed for use with electric motors and operates using a plate cam—with one or more cams—mounted on the motor shaft, it being possible to block the plate cam using an electromagnetically actuatable lever. The principle shown here is designed only for use with low-power electric motors and, due to the design of the locking device, does not allow for closely stepped locking.

### SUMMARY OF THE INVENTION

It is therefore an object of the present invention to provide a holding device that enables axles to be locked with minimum play while ensuring the most compact overall configuration possible and easy installation. Furthermore, a method will be provided that ensures reliable operation of the holding device.

The present invention achieves this object by the fact that a holding device with a holding element that interacts with a shaft is used, the holding element being positioned preferably coaxial with the shaft and being capable of assuming at least two positions, one position releasing the shaft and the other position locking the shaft. The holding element and the coupling positioned coaxial with the shaft includes a matching surface structure located on the contact side that, upon contact, holds the position of the shaft.

The coupling element on the shaft is designed to ensure a non-positive or form-locked connection between the holding element and the shaft, thereby allowing the shaft to be held with minimum play, depending on the axial position of the holding element. The required and most backlash-free locking is ensured by the fact that the coupling is positioned coaxial with the shaft and, therefore, the surface structure can be located along the circumference of the shaft in a seamless or nearly seamless manner, which enables engagement of the holding element nearly independently of the instantaneous position of the shaft.

The magnitude of the angular displacement that occurs when the locking mechanism is engaged depends substantially on the type and fineness of the surface structure. A surface structure designed for friction, similar to that of sandpaper, has a finer resolution than a surface structure with a toothed structure. Both versions are possible, depending on the application, although a toothed structure is preferred due to its greater stability and lower wear.

The present invention ensures the required compactness of the device due to the preferably coaxial positioning of the holding element and the fact that the position of the coupling is always coaxial. Using this concept, the space in the immediate vicinity of the shaft that is usually not utilized can be utilized in an optimum manner and nearly no additional installation space is required. To install, the holding element is simply slid onto the shaft in the axial direction and fastened, e.g., to the shaft housing.

There are numerous embodiments and applications of the means of achieving the object of the present invention. A few of these embodiments will now be discussed in detail.

Preferably, at least two positions of the holding element are detected by at least one electric position-detection device, so that the current position of the holding element can be monitored and reported to a controller.

Particularly preferably, an annular coupling element is coupled with the shaft via a preloaded form-locked connection or a non-positive connection or an integral connection or a detachable connection and has circumferential and gapless toothing on its exterior. As an alternative or in addition thereto, toothing can be provided on one or both end faces. As a result, the coupling element can also be integrated subsequently into existing systems, and it is easy to install.

As an alternative to the previous method, the coupling element and the shaft can be configured as a single component. As a result, the number of steps required to manufacture and assemble new products is reduced, which, in turn, reduces manufacturing costs.

In a very particularly preferred manner, the holding element undergoes a reversing motion in the direction of the shaft axle, to lock or release. This contributes to the compactness of the means of achieving the object.

As an alternative to the previous means of achieving the object, the holding element includes a radially-positioned lever that is rotatably supported and can be moved in parallel with the shaft in a clamping plane that is radial to and parallel with the shaft. The available space is utilized in an optimum manner in this case as well, the movement of the holding element being reduced only to the motion of one or more arms, which also requires less force.

Provided that adequate installation space is available, the holding element can include a reversing plunger located radially to the shaft, the plunger having a surface that matches the coupling surface, to lock the shaft in a non-positive or form-locked manner. The advantage of this configuration is that not all of the space around the shaft is used, therefore allowing it to be used for another purpose, if necessary.

Advantageously, the motion of the holding element is realized via a permanent magnet and/or an electromagnet and/or a spring. The permanent magnet secures, e.g., the first locked state, and the spring secures the second locked state. The electromagnet is used to switch between the states. This is a simple and low-maintenance method for releasing or locking the shaft.

As an alternative to the means of achieving the object stated above, at least one holding element with a hinged lever could be located such that it is movable radially relative to the shaft, the hinged lever being located such that it is movable within an electromagnetic field using the motion of a reversing soft-magnetic and/or ferromagnetic core. This means of achieving the object is preferred when the preferably coaxial arrangement of the holding element is not possible, e.g., during retrofitting.

Combining the holding device with a service brake ensures an optimum level of safety for a system, the device according to the present invention functioning as a holding brake. The service brake can be used to brake a rotating shaft, while the holding brake engages only when the rotational speed of the shaft has already been reduced substantially by the service brake and a heavy load must be held.

To realize a compact design, it is particularly advantageous for the holding device to be enclosed in the same housing that encloses the shaft. For example, by a motor housing or a separate housing installed on the motor housing. An extraordinarily advantageous embodiment of the present invention uses a tensioning element, preferably a spring, which is positioned such that the holding device is self-retaining if there is an electrical power failure.

To improve stability, the coupling element has spur toothing or helical toothing, the flank profile of the toothing being, e.g., cycloid toothing, lantern gear toothing or involute toothing with a symmetrical or asymmetrical tooth cross section. The advantages of the present invention are realized, in particular, when the holding device is used, in one of the embodiments described above, in an electrically controlled machine with a movable axle, because machines of this type (machine tools, injection moulding machines, parts of production lines) often require compact designs and reliable operating modes. When used for a motor, in particular asynchronous or synchronous motors, a holding device according to one of the embodiments described above can be used advantageously as a holding brake.

The holding device is preferably connected to a controller that controls an axle equipped with the holding device and evaluates the locking position using an operating program. This function could also be already integrated in a drive controller operated with or without control. Both concepts fulfill the requirements on modern automation systems. The last embodiment described contributes to greater modularity of the system.

A shaft is secured using the device according to the present invention using the following method steps, regardless of the sequence in which they are carried out:
a) Detect the rotational speed of the shaft,
b) Brake the shaft drive,
c) Lock the shaft when the actual rotational speed falls below a threshold value,
d) Detect the position of the locking.

The rotational speed of the shaft must be detected in order to obtain feedback about the forces occurring on the circumference of the shaft, to initiate the braking phase of the shaft drive, and to detect the correct instant for locking. As soon as the rotational speed of the shaft is sufficiently low or, optimally, zero, the locking mechanism engages and holds the shaft in place. The rotational-speed threshold should be selected such that damage to the holding element or the coupling is ruled out and the wear that occurs during engagement is minimal. The instantaneous position of the locking is subsequently detected for monitoring purposes and is corrected, if necessary.

With this method, the situation is prevented, for example, in which, if there is a power failure in the braking control for a shaft, the holding device is not automatically triggered at a higher rotational speed. It is triggered only when the shaft is at a standstill. If the drive fails, a certain amount of time passes before this standstill occurs, since the rotational speed of the shaft decreases slowly due to bearing friction.

Furthermore, to protect the brake if a malfunction should occur, the locked stated that existed when the malfunction occurred is retained. This means that, if the power supply to the shaft drive fails, a locked shaft remains locked and a released shaft remains released. This ensures that, if a shaft is still rotating after the power fails, an attempt will not be made to lock it immediately using the holding brake. This would destroy the toothing and, therefore, the effectiveness of the brake. In contrast, a shaft that is already locked also remains locked as soon as it is determined that the shaft drive is not functional.

The novel features which are considered as characteristic for the present invention are set forth in particular in the appended claims the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 Shows an axially displaceable holding device with external toothing.

FIG. 2 Shows a holding device with radial swivel arms

FIG. 3 Shows a holding device with radial plungers

FIG. 3a Shows a holding toothing in detail

FIG. 4 Shows a holding device with hinged arm

FIG. 4a Shows a holding toothing in detail

FIG. 5 Shows an axially displaceable holding device with spur toothing

FIG. 6 Shows possible embodiments of the teeth

FIG. 7 Shows a combination of service and holding brake

FIG. 8 Shows status information and the course of a holding procedure over time

### DESCRIPTION OF THE PREFERRED EMBODIMENTS

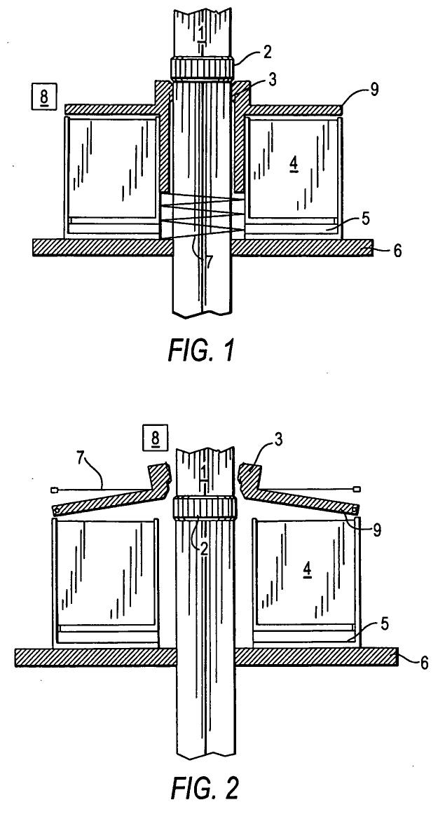

FIG. 1 shows a shaft 1 with shaft toothing 2 on an annular element located on the shaft, a holding element 9 with holding toothing 3, a winding 4, a permanent magnet 5, a supporting plate 6, a spring 7 and a position sensor 8. Holding element 9 is positioned coaxial to shaft 1 and is usually fixedly connected with a housing (not shown). Spring 7 bearing against supporting plate 6 exerts pressure on the part of holding element 9 that is movable relative to shaft 1, so that holding toothing 3—which is advantageously located annularly around shaft 1—engages in shaft toothing 2 and ensures a form-locked, stiff connection between holding element 9 and shaft 1.

Due to the connection of holding element 9 with the housing, it is therefore possible to block shaft 1 from rotating. This blocking continues for as long as forces greater than the spring force do not occur in the opposite axial direction. An application of force of this nature can be achieved using winding 4. The spring force is compensated for when the force of attraction of the magnetic field of winding 4 is greater than the spring force itself. Winding 4 then acts like a switch and, depending on whether or not it is energized, induces a switch between the shaft states “released” and “locked”.

As an option, the position of holding element 9 can be detected using a position sensor 8, and a message can be generated that reports the positions detected to higher-order processes. The position sensor can operate in a contact-based or contactless manner.

The statements made with regard for FIG. 1 also apply to a substantial extent for FIG. 2, although, in this case, one or more levers with toothing distributed around the circumference engage in matching toothing on the shaft in a form-locked manner. In this case, the holding element is not designed rigid with annular toothing, as in FIG. 1. Instead, it includes movable components with toothing, the movable components being capable of inducing locking and which are preloaded by a spring 7.

The “locked” state is secured via permanent magnet 4 in that the lever of holding element 9 is guided in the direction of the magnet by the magnetic field. The “released” state is realized using the spring. In this case as well, the field generated by winding 4 serves to switch between these two states.

Contactless or contact-based detection of the position of holding element 9 can also be integrated in this case.

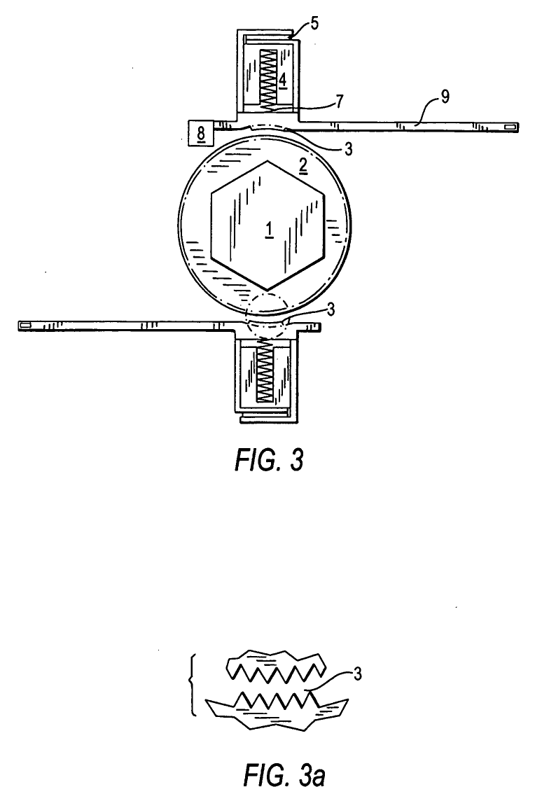

FIG. 3 shows a further alternative to the implementation of the means of achieving the object according to the present invention. One or more levers 9 with toothing distributed around the circumference engage in a matching toothing 2 on shaft 1 and, in this manner, create a form fit between shaft 1 and lever 9. The “released” state is secured using a permanent magnet 5. The “locked” state is realized using spring 7. Winding 4 serves to switch between these two states. With this means of achieving the object, however, a combination of winding/spring and permanent magnet is required for each lever, and the levers must be controlled in parallel, while the means of achieving the object shown in FIGS. 1 through 2 permit the use of annular components, so that only one controller is required. As an option, the position of lever 9 can also be detected with the means of achieving the object according to FIG. 3. FIG. 3a shows a detained view of the possible realization of shaft and holding toothing interlocking in a form-locked manner.

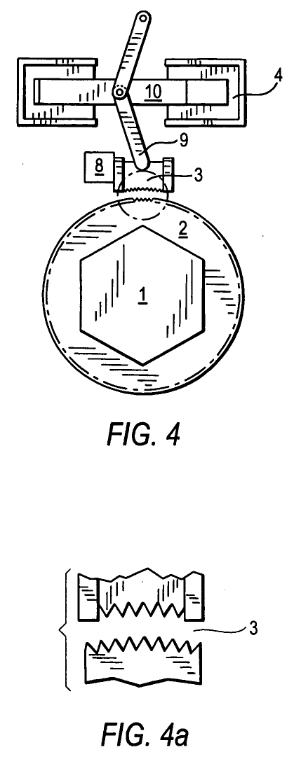

FIG. 4 shows a means of achieving the object that utilizes a hinged lever 9 as the holding member. The head of the hinged lever is equipped with toothing that engages in the shaft toothing in a form-locked manner. In the “released” state, the joint is bent, and in the “locked” state, the joint is fully extended. Winding 4 serves to switch between the two states. Position sensor 8 detects the position of hinged-lever head 9 in the space and reports it, if necessary, to a higher-order controller or a drive controller. Only one hinged lever is shown in this example.

It is possible, of course, and even recommended, depending on the amount of force required, to allow a plurality of hinged joints to engage around the circumference of the shaft, so that the forces are superposed. To prevent loading the shaft bearing on one side, hinged levers 9 should be distributed around the circumference of the shaft in the most coaxial, equidistant manner possible, so that the unilateral forces acting on the bearing cancel each other out. In this case as well, a spur gear of the type shown in FIG. 4 can be used to create a form-locked connection.

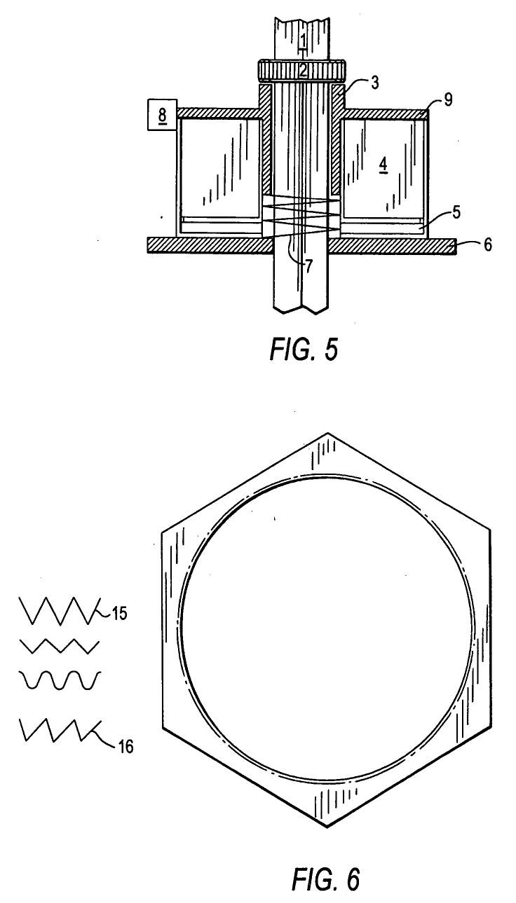

Regarding the design of the present invention according to FIG. 5, the statements made with regard for FIG. 1 also apply, with the exception that toothing 2 on shaft ring is not located on its exterior, but on its front side facing the holding element. Accordingly, holding element 9 does not have holding toothing 3 on its interior located coaxial with shaft 1, but on a front side that is coaxial around shaft 1. The mode of operation of locking and releasing the shaft is identical to the embodiment described with reference to FIG. 1.

FIG. 6 shows that a large number of tooth systems are possible in order to influence the properties of the form-locked connection between shaft 1 and holding element 9. A spur toothing or helical toothing can be used, as well as flank profiles of cycloid toothing, lantern gear toothing, or involute toothing with a symmetrical or asymmetrical tooth cross section. Further types of toothing are feasible. In general, all possible embodiments of mating projections and recesses are suitable.

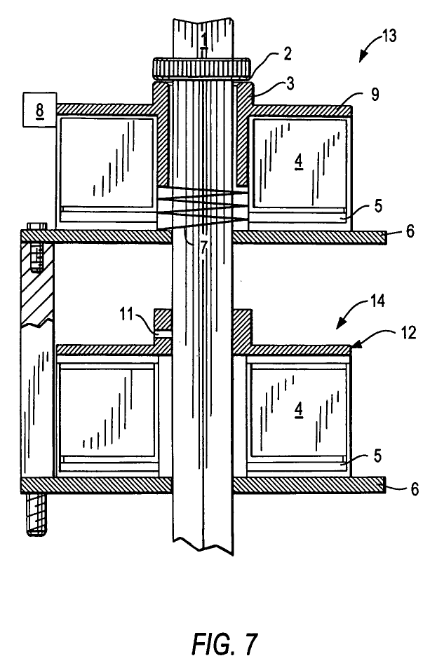

FIG. 7 shows the holding device described with reference to FIG. 5 as a holding brake 13, which is located, together with a service brake 14, coaxial to a shaft 1. The two brakes are fixedly coupled with each other using connecting element 17 and are preferably also connected with the housing that encloses shaft 1. The service brake operates using a brake disk located on carrier 12. A part of service brake 14 is connected with shaft 1 via hub 11. This combination requires a very small amount of installation space and enables the realization of a braking device for a shaft by reducing the rotational speed and subsequently securing the shaft, e.g., to protect individuals standing under hanging, heavy loads.

The holding device that locks the axle can form an installation unit with additional holding brakes that operate using, e.g., on a friction pairing.

The combination of holding and/or service brakes can also be located separately and outside of the drive motor, or they can be installed in a separate housing on the machine.

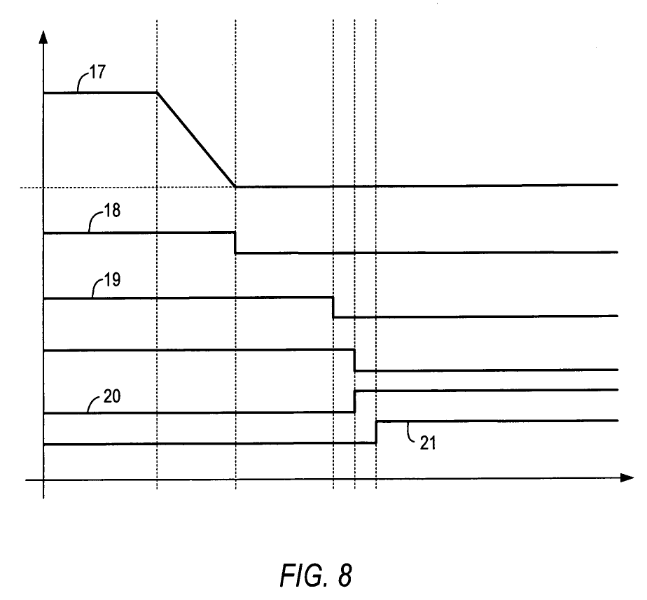

FIG. 8 shows the course of the characteristic signals over time for securing a shaft 1 using holding device 13. Signal 17 shows the course of the rotational speed of the motor, which decreases in the manner of a ramp until it reaches a standstill. Signal 18 indicates the drive status. If the rotational speed is not equal to zero, the signal level is in the high state, and in every other case it is in a low state. Signal 19 indicates whether the protective screen is extended (high) or retracted (low). Signals 20 indicate the status of the holding device, i.e., whether it is open or closed. Finally, signal 21 indicates whether the protective screen is released or locked. Certain delay times on the flanks of the signals are noticeable. They are due, e.g., to signal transfer times.

To trigger the holding device (brake)—which locks the axle—according to the present invention, signal 18 is evaluated first, because it indicates the instant when the rotational speed of the motor becomes zero.

The holding device cannot be activated until the status of the drive (signal 18) and protective screen (signal 19) or a comparable “Emergency Off” signal are suitable. Specifically, this means that the holding device cannot lock the shaft until the rotational speed of the drive is zero and the protective screen has been extended. Otherwise, due to the form-locked toothing, enormous forces could occur between the shaft and the holding device that would destroy the toothing and result in faulty locking.

Friction brake 14 and service brake 14 described with reference to FIG. 7, which can operate in conjunction with holding device 13; is not subject to limitations of this type and can therefore be activated or deactivated at any time, e.g., to brake the rotational speed of the shaft to zero.

As soon as the holding device has been activated and the shaft is locked, this information is communicated (signal 20) and, only after this feedback has been provided, individuals are permitted to enter the working area and release the protective screen. One skilled in the art can link the signals in a suitable, logical manner and describe other evaluation mechanisms.

It will be understood that each of the elements described above, or two or more together, may also find a useful application in other types of constructions differing from the types described above.

While the invention has been illustrated and described as embodied in a holding device, it is not intended to be limited to the details shown, since various modifications and structural changes may be made without departing in any way from the spirit of the present invention.

Without further analysis, the reveal will so fully reveal the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims:

1. A holding device, comprising an electrically controlled holding element; a shaft with a coupling that interacts with said holding element, said holding element being positioned coaxially with said shaft and assuming at least two positions including a first position releasing said shaft and a second position locking said shaft, said holding element and said coupling having a matching surface structure.

2. A holding device as defined in claim 1, wherein said holding element is positioned coaxially with said shaft.

3. A holding device as defined in claim 1; and further comprising at least one electric position-detecting device which detects said at least two positions of said holding element.

4. A holding device as defined in claim 1, wherein said coupling element is connected with said shaft by a connection selected from the group consisting of a preloaded form-lock connection, a non-positive connection, an integral connection, and a detachable connection, and has a toothing on a part selected from the group consisting of an exterior, an end face, and both.

5. A holding device as defined in claim 1, wherein said coupling element and said shaft are configured as a single component.

6. A holding device as defined in claim 1, wherein said holding element is arranged so that it undergoes a reversing motion in a direction of an axle of said shaft.

7. A holding device as defined in claim 1, wherein said holding element includes a radially-positioned lever.

8. A holding device as defined in claim 1, wherein said holding element is positioned radially relative to said shaft and includes at least one plunger that is movable in a radial and reversing manner.

9. A holding device as defined in claim 1; and further comprising an element selected from the group consisting of a permanent magnet, an electromagnet, and a spring and operative for a movement of said holding element.

10. A holding device as defined in claim 1, wherein said holding element with a hinged lever is positioned such that said holding element is movable relative to said shaft, and said hinged lever is driven via a reversing motion of a core selected from the group consisting of a soft-magnetic core and a ferromagnetic core, within an electromagnetic field.

11. A holding device as defined in claim 1, wherein the holding device is located, as a holding brake together with a service brake on said shaft.

12. A holding device as defined in claim 1; and further comprising a housing which encloses the holding device and also said shaft.

13. A holding device as defined in claim 1, wherein the holding device is self-retaining and uses a preload element if there is an electrical power failure.

14. A holding device as defined in claim 13, wherein said preload element is a spring.

15. A holding device as defined in claim 1, wherein said coupling element has a toothing selected from the group consisting of a spur toothing and a helical toothing, with a flank profile selected from the group consisting of a cycloid toothing, a lantern gear toothing and an involute toothing with a tooth cross-section selected from the group consisting of a symmetrical tooth cross-section and an asymmetrical cross-section.

16. An electrically controlled machine with a movable axle, wherein said axle is lockable with the holding device as defined in claim 1.

17. A motor selected from the group consisting of asynchronous motor and a synchronous motor and including the holding device as defined in claim 1.

18. A controller, wherein the controller controls an axle with the holding device as defined in claim 1, and evaluates the locking position.

19. A drive controller, wherein the drive controller controls an axle with the holding device as defined in claim 1 and evaluates the locking position.

20. A method for securing a shaft, comprising the steps of using the device as defined in claim 1, and carrying the steps including detecting a rotational speed of the shaft, braking a shaft drive, locking the shaft if an actual rotational speed falls below a threshold value, and detecting a position of the locking.

21. A method as defined in claim 20; and further comprising, if a malfunction occurs, retaining a locking state that existed when the malfunction occurs.

22. A method as defined in claim 20; and further comprising, if an electrical power failure occurs, a locked shaft remains locked and a released shaft remains released.
